(19) United States
(12) Patent Application Publication
(10) Pub. No.: US 2026/0048330 A1
(43) Pub. Date: Feb. 19, 2026

(54) DYNAMIC TRIVIA QUESTION GENERATION

(71) Applicant: AMI Entertainment Network, LLC, Great Rapids, MI (US)

(72) Inventors: Kapil MISTRY, Palatine, IL (US); Danny GARRETT, Batavia, IL (US)

(21) Appl. No.: 19/299,803

(22) Filed: Aug. 14, 2025

Related U.S. Application Data
(60) Provisional application No. 63/683,042, filed on Aug. 14, 2024.

(51) Int. Cl. A63F 13/80; A63F 13/35; A63F 13/798

(52) U.S. Cl. CPC A63F 13/80; A63F 13/35; A63F 13/798

(57) ABSTRACT

A system for dynamically generating trivia questions includes a server and a content output device deployed at the venue and connected by a network to the server. The content output device is communicatively couplable to display devices at the venue and configured for communication with user devices participating in the multiplayer trivia game at the venue. The server is configured to receive venue data from the content output device, receive patron data associated with users of the user devices, generate or compile one or more trivia questions based on at least one of the venue data or patron data, and transmit the trivia questions to the content output device. The content output device is configured to present at least one of the trivia questions on the display devices and/or the user devices, and receive, from the user devices, responses to the trivia questions.

### CROSS-REFERENCE TO RELATED APPLICATIONS

This application claims the benefit of U.S. Provisional Patent Application No. 63/683,042, filed Aug. 14, 2024, entitled “Dynamic Trivia Question Generation,” currently pending, the entire contents of which are incorporated by reference herein.

### BACKGROUND

Embodiments described herein relate generally to venue-based multiplayer games, and more particularly, to a method and system for dynamically generating questions for multiplayer trivia games in an amusement device network.

Venues such as bars, restaurants, and casinos, often supplement their services by providing multimedia content for the enjoyment of patrons. Outputting content that is relevant to patrons of a venue may encourage patrons to remain at the venue for longer periods of time, thereby allowing the venue to increase per-patron revenue. Furthermore, presenting desirable content may attract new and repeat patrons to a venue.

Such content is typically output on display devices deployed at the venues, such as televisions, projectors, or computer monitors. Typically, a content output device, such as a computer, set-top box, disc player, or media-streaming device, is communicatively coupled to the display device. The content output device may receive and/or read content from a medium or network such as the Internet, a cable television network, a satellite, or an optical or mass storage medium. Another method for increasing engagement in a venue is to provide games, particularly multiplayer games. Venues have started to leverage patrons' mobile devices as part of the gaming experience, which reduces the cost and need for dedicated gaming machines and enables a broader engagement by patrons through accessibility and ease of use.

Multiplayer trivia games are very popular in venue-based gaming. However, the questions for such games are conventionally written months in advance and are delivered to the venue, such as on a physical memory drive or online. By the time the game is initiated, some of the questions may have become outdated. Moreover, the questions may not be particularly interesting or relevant to the patrons present at the venue during the game. These scenarios result in less participation from lack of interest and/or inability to answer the questions posed.

It is desirable to provide a technology solution to increase patron engagement in multiplayer trivia games at a venue by enabling generation of questions in real-time having relevance and interest to the patrons.

### BRIEF SUMMARY

Briefly stated, one example embodiment comprises a system for dynamically generating trivia questions for a multiplayer trivia game at a venue. The system includes a server and a content output device deployed at the venue and connected by a network to the server. The content output device is communicatively couplable to one or more display devices deployed at the venue and configured for communication with one or more user devices participating in the multiplayer trivia game at the venue. The server is configured to receive venue data from the content output device over the network, receive patron data associated with users of the one or more user devices participating in the multiplayer trivia game at the venue, generate or compile one or more trivia questions based on at least one of the received venue data or patron data, and transmit the one or more trivia questions to the content output device over the network. The content output device being configured to present at least one of the one or more trivia questions on at least one of the one or more display devices or the one or more user devices participating in the multiplayer trivia game, and receive, from the one or more user devices participating in the multiplayer trivia game, responses to the at least one of the one or more trivia questions.

In one aspect, the system further includes a jukebox deployed at the venue and communicatively coupled to the content output device. In a further aspect, the venue data provided by the content output device to the server includes an identification of music at least one of currently playing on or recently played on the jukebox. In a still further aspect, the identification of music includes at least one of music genre, artist name, or lyrics.

In another aspect, the patron data includes identification of user accounts associated with each of the users of the one or more user devices participating in the multiplayer trivia game at the venue. In a further aspect, the server is configured to, upon receiving the identification of a particular user account, pull additional patron data for the user associated with the particular user account.

In yet another aspect, the venue data provided by the content output device to the server includes an identification of video content at least one of currently displaying on or recently displayed on at least one of the one or more display devices at the venue.

In still another aspect, the patron data includes at least one of age, education, interests, favorites, or occupation of each of the users of the one or more user devices participating in the multiplayer trivia game at the venue.

In yet another aspect, the patron data is received by the server from the one or more user devices participating in the multiplayer trivia game at the venue.

In still another aspect, the server includes a database of possible trivia questions, the server being configured to compile the one or more trivia questions from the database based on the at least one of the received venue data or patron data.

Another example embodiment comprises a method of operating a multiplayer trivia game with dynamically generated trivia questions at a venue. A content output device is deployed at the venue and connected by a network to a server. The content output device is communicatively couplable to one or more display devices deployed at the venue and configured for communication with one or more user devices participating in the multiplayer trivia game at the venue. The method includes sending, by the content output device, venue data over the network to the server, and receiving, by the content output device, one or more trivia questions over the network from the server. The one or more trivia questions are generated or compiled by the server based on at least one of the venue data or patron data associated with users of the one or more user devices participating in the multiplayer trivia game at the venue. The method further includes presenting, by the content output device, at least one of the one or more trivia questions on at least one of the one or more display devices or the one or more user devices participating in the multiplayer trivia game, and receiving, by the content output device, responses to the at least one of the one or more trivia questions from the one or more user devices participating in the multiplayer trivia game.

In one aspect, the content output device is communicatively coupled to jukebox deployed at the venue, and the venue data sent by the content output device over the network to the server includes an identification of music at least one of currently playing on or recently played on the jukebox. In a further aspect, the identification of music includes at least one of music genre, artist name, or lyrics.

In another aspect, the method further includes sending, by the content output device, the patron data over the network to the server. In a further aspect, the method further includes receiving, by the content output device, the patron data from the one or more user devices participating in the multiplayer trivia game at the venue.

In yet another aspect, the method further includes initiating, by the content output device, the multiplayer trivia game. In a further aspect, the content output device performs the initiating step in response to receiving a request to play from at least one of the one or more user devices.

In still another aspect, the venue data sent by the content output device over the network to the server includes an identification of video content at least one of currently displaying on or recently displayed on at least one of the one or more display devices at the venue.

In yet another aspect, the patron data includes at least one of age, education, interests, favorites, or occupation of each of the users of the one or more user devices participating in the multiplayer trivia game at the venue.

In still another aspect, the method further includes determining, by the content output device based on the responses received to the at least one of the one or more trivia questions from the one or more user devices participating in the multiplayer trivia game, a winner of the multiplayer trivia game, and identifying the winner on at least one of the one or more display devices at the venue.

### BRIEF DESCRIPTION OF THE SEVERAL VIEWS OF THE DRAWINGS

The following detailed description of preferred embodiments will be better understood when read in conjunction with the appended drawings. For the purpose of illustration, there are shown in the drawings embodiments which are presently preferred. It should be understood, however, that the invention is not limited to the precise arrangements and instrumentalities shown.

In the drawings:

FIG. 1 is a schematic block diagram of an example embodiment of a multiplayer gaming and display system;

FIG. 2 is a sequence diagram of steps for initiating and conducting a multiplayer trivia game in accordance with an example embodiment;

FIG. 3 is an example display screen inviting patrons to join an initiated multiplayer trivia game;

FIG. 4 is an example graphical user interface for joining a multiplayer trivia game on a mobile device; and

FIG. 5 is a schematic flow diagram of venue data and responsive trivia question transmission between a content output device and a server in accordance with an example embodiment.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

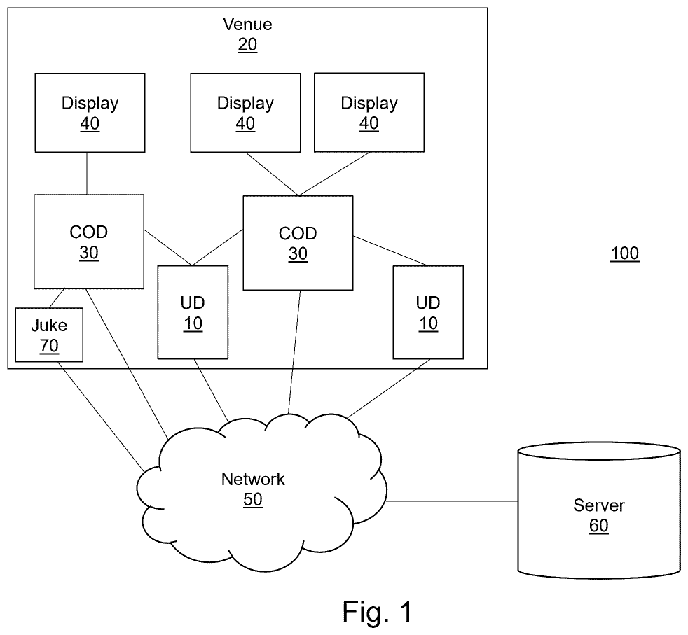

Referring to the drawings in detail, wherein like reference numerals indicate like elements throughout, FIG. 1 is a system diagram of an example embodiment of a multiplayer gaming and display system 100 according to the present invention. One or more servers 60 may be connected by a network 50 to one or more content output devices (CODs) 30 deployed at a venue 20. While only a single venue 20 is shown in FIG. 1, multiple venues 20 may be connected to the server(s) 60, each having its own COD(s) 30. Accordingly, the network 50 may be a wide area network, such as the Internet, although other types of networks may be used as well, including where the system 100 is confined to a single venue 20 housed internally.

The server(s) 60 may be provided in a variety of configurations. For purposes of discussion, a single server 60 is shown and described and is configured to perform multiple functions. The server 60 may be a computing device and include one or more physical or virtual servers and may be implemented using purpose-built or general purpose computing hardware comprising processors for execution of program code for performing the processes described below, memory for storing program code and data, and interfaces for communications. Furthermore, the server may utilize separate database servers for storage and retrieval of data, as well as other specialized servers or devices for other functions.

However, it is to be understood that these functions may be combined or separated as needed for a particular implementation within the scope of the invention. Functions may be distributed among multiple servers and implement an N-tier server infrastructure having one or more application servers, one or more web servers, one or more database servers, or the like. Such servers may connect to each other through a local area network, not shown, or, in some cases, via network 50. The server 60 (or portions thereof) may be remotely located from the venue 20, although in some embodiments, the server 60 may reside locally at the venue 20.

As an example, the server(s) 60 may receive, store, and provide information regarding locations of user devices 10 and CODs 30, provide various services to user devices 10 connecting to the system 100, may provide functions related to one or more multiplayer games including, for example, trivia games, provide message translation and/or load balancing functions, and/or other like functions for operating the system 100.

Each venue 20 may have one or more CODs 30 configured to output content to one or more communicatively coupled display devices 40. Each COD 30 may be any device capable of receiving and/or reading multimedia content and outputting the multimedia content to a display device 40. For example, the CODs 30 may be digital receivers, computer devices, multimedia streaming devices such as APPLE TV, ROKU, CHROMECAST, cable television set-top boxes, satellite television receivers, or the like. In some embodiments, each COD 30 is a small computer running a variant of the Linux operating system and additional software. The display devices 40 may be any electronic devices capable of outputting multimedia content to one or more patrons of the venue 20, such as televisions, projectors, monitors, or the like. There is no limit to the number of CODs 30 and display devices 40 that may be deployed at any particular venue 20. Furthermore, each COD 30 may output to more than one display device 40. In some embodiments, a COD 30 and a display 40 may be combined in a single unit.

In the example embodiment of FIG. 1, the venue 20 includes two CODs 30, the first of which is connected to two different display devices 40 and the other of which is connected to only a single display device 40. Other venues 20 may also include various combinations of CODs 30 and display devices 40. If there are multiple CODs 30 at one venue 20, they will preferably display the same content. In the event that the CODs 30 at a particular venue 20 are running different versions of software, associations may be made such that the player connects with games on a server 60 with which the COD 30 with the newer version of software is communicating. In some embodiments, subsets of CODs 30 in a venue 20 may be used to allow display of views of multiple games at a time or display of advertising or other content programming simultaneously with one or more games.

The venue 20 may further include a venue controller (not shown) that is communicatively coupled to each of the CODs 30 deployed at the venue 20 by a local network, not shown. The venue controller may provide a centralized graphical user interface (not shown) for controlling the plurality of CODs 30 deployed at the venue 20. The venue controller may allow venue personnel to change the content output settings (e.g., channel change, volume change, audio source change, and/or the like) for one or more CODs 30 deployed at the venue 20. In some embodiments, such a venue controller is the TAP.tv controller from AMI ENTERTAINMENT NETWORK. Such a venue controller may serve as an intermediary between the CODs 30 deployed at the venue 20 and the server 60 by aggregating data from the CODs 30 deployed at the venue 20 over a local network, not shown. The venue controller may transmit the aggregated data over the network 50 to the server 60. It should be understood that not all venues 20 must have a venue controller. CODs 30 deployed at venues 20 that do not have a deployed venue controller may individually communicate with the servers 60 over the network 50. In other embodiments, one or more CODs 30 may be configured to provide the same or similar functionality as a venue controller.

To participate in games and interact with the COD(s) 30, patrons to the venue 20 may utilize user devices 10. Typically, the user device 10 will be a mobile phone, although other examples of user devices can include a tablet, netbook or laptop, a dedicated currency operated amusement device, or any other electronic device having input and output interfaces for communicating with the COD(s) 30 and/or the server(s) 60.

Interaction between players and the system 100 is preferably facilitated by a mobile device application. The mobile device application may include, for instance, program code and data to facilitate connection to server(s) 60, acceptance of game input, and rendering of game state, which can be for a variety of games or a single game. In some embodiments, the mobile device applications are applications for the Apple IOS, Google Android, Windows Mobile, and other operating systems, and are made available for free download or purchase to users of those systems.

In some embodiments, upon launch, the mobile device application may first consult a specified URL or other identified location for information regarding an address of the server 60 or other servers to be contacted. The application may then make a services request to the specified server. The services request will preferably be accompanied by an authentication token known only to authorized mobile device applications. In some embodiments, the application may also be directed to a specific messaging server or similar functional portion of the server 60, or the like. In still other embodiments, the game may be browser-based and accessible without prior installation of a specific application, wherein the user device 10 may be directed to a specific website or other URL to access game functionality.

In some embodiments, the venue 20 may have one or more jukeboxes 70 configured to output audio content, optionally with video content. The jukebox 70 may connect to the server 60 over the network 50. Digital music/video files may be stored on the server 60 for retrieval and play by the jukebox 70, such as by download or streaming, although such files may also be stored elsewhere on the network and/or locally in memory of the jukebox 70 itself or elsewhere at the venue 20 in a location accessible by the jukebox 70. The jukebox 70 may connect to one or more of the display devices 40 in the venue for content output. Alternatively or additionally, the jukebox 70 may have an audio output coupled to one or more speakers (not shown) deployed at the venue 20. The jukebox 70 may also connect to one or more of the CODs 30 and/or the venue controller. The jukebox 70 may have its own display and a user interface to allow users to make content selections, although in some embodiments, users may be able to make content selections at the jukebox 70 using their user devices 10, connected directly to the jukebox 70 or via the network 50 or some other wireless or wired connection. In some embodiments, the jukebox 70 may include at least one of a coin, bill, or credit card acceptor for receiving payment for use. However, in other embodiments, the user may debit an account stored at the server 60 or elsewhere on the network 50 using the jukebox 70 interface or their user device 10, or may pay using their user device 10, such as by credit card, mobile pay app, or the like. While shown separately in FIG. 1, in some embodiments, a COD 30 may be deployed within a jukebox 70.

Using the COD(s) 30 and display device(s) 40 deployed at the venue 20, a multiplayer trivia game can be facilitated. The multiplayer trivia games can be pre-scheduled to occur at specific times of day, or they may be requested to be initiated on demand by venue patrons and/or staff. When the multiplayer trivia games are pre-scheduled, at least one of the CODs 30 may output a notification that a multiplayer trivia game is set to begin at a particular time, and optionally starts a countdown timer prior to that time. The notification may be displayed to venue patrons on one or more of the display devices 40 and/or on user devices 10 of patrons who have previously indicated a preference to be notified.

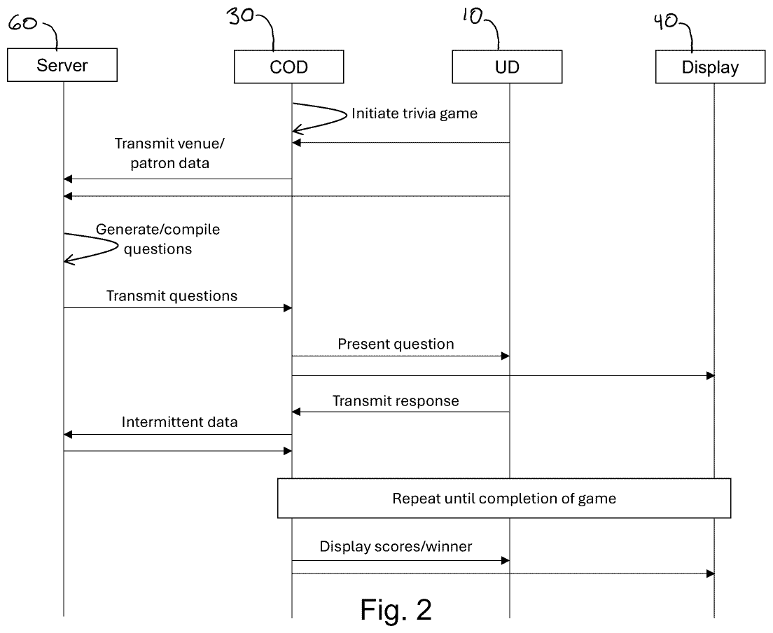

FIG. 2 is a sequence diagram of steps for initiating and conducting a multiplayer trivia game in accordance with an example embodiment. A trivia game may be initiated at one of the CODs 30. In some embodiments, the COD 30 may self-initiate the trivia game based on a previously scheduled event (e.g., a trivia game scheduled in the system to begin at 9:00 PM on Thursdays) or based on certain detected conditions within the venue 20, such as a requisite number of patrons, a lack of current output of entertainment content by the COD(s) 30, display devices 40, and/or the jukebox 70 (e.g., one or more of the devices are currently idle), combinations thereof, or the like. An owner or operator at the venue 20 may also initiate the trivia game on demand by selecting an option through a user interface (not shown) of the COD 30, such as a remote control, keyboard, touchscreen, or the like. It may be further possible in certain embodiments for a patron to initiate the trivia game by selection using their respective user device 10. The trivia game may be initiated by transmitting a request from the user device 10 to the COD 30, which then initiates the game as a result of the request. The request may be transmitted in response to an advertisement by the COD 30, through the display device(s) 40 or directly to the user device 10 that a trivia game is available for play, or the user may send the request independently of any solicitation from the COD 30. For example, the COD 30 may present a QR code on the display device 40 or jukebox 70 display, whereupon a user device 10 scanning the QR code results in a message being sent by the user device 10 to the COD 30 and/or server 60 to initiate a trivia game. However, other methods, such as having the user manually enter information using the user device 10 or the like may be utilized as well to allow user initiation of game play. Preferably, once the trivia game is initiated for play, other users are prevented from selecting a different game to initiate at the COD 30. However, in larger venues 20, it may be possible to run multiple trivia games simultaneously using different CODs 30 or the like.

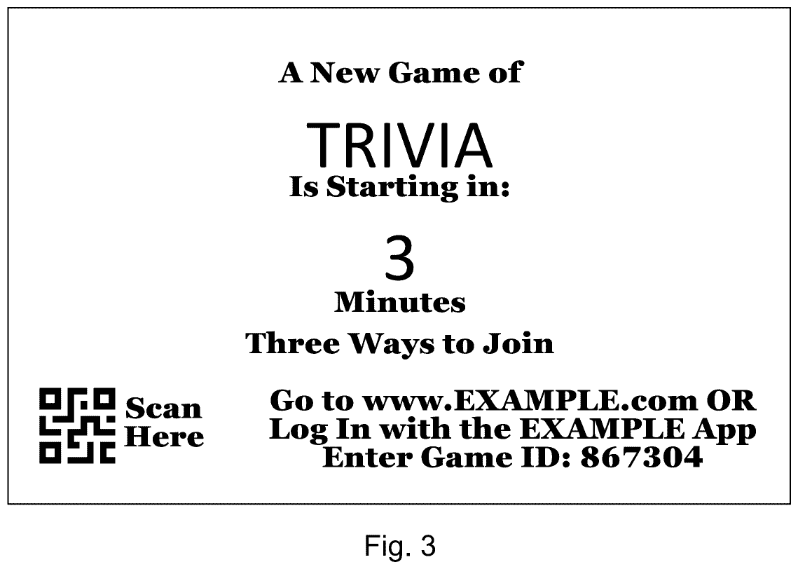

Once the trivia game is initiated, other patrons at the venue 20 may be invited to join the game. For example, the COD 30 may transmit a notification to other user devices 10 at the venue 20 and/or provide a general invitation on one or more of the display devices 40, such as via a scannable QR code, URL, or other visual notifications, such as the invitation shown in example FIG. 3. An amount of time remaining for patrons to join the game may be displayed on the user devices 10 and/or display devices 40. In other embodiments, where a limited number of players are required, instead of a countdown to the start of the game, the COD 30 may display the number of joined players and wait for the requisite number of players to join the initiated game. Patrons may join an initiated game using their respective user devices 10. Example methods for initiating and inviting patrons to join a game are described in U.S. Patent Application Publication No. 2013/0288801, which is attached hereto. In some embodiments, patrons may join games already in progress.

While additional players are being solicited or after the number of players is confirmed, the COD 30 may send venue and/or patron data to the server 60. Venue data may include, but is not limited to, for example, music being currently and/or recently played or selected on the jukebox 70 or otherwise at the venue 20 (e.g., which can include information related to music genre, artists, lyrics, combinations thereof, and the like), video content being currently and/or recently displayed on one or more of the display devices 40 or otherwise at the venue (e.g., sports game(s), television programming, movies, combinations thereof, and the like), number of patrons currently at the venue 20, current or upcoming promotions or events at the venue 20 (e.g., food and/or drink promotions, theme nights, birthday parties, retirement parties, bachelor/bachelorette parties, combinations thereof, and the like), staff on premises at the venue 20, current weather at the venue 20, performers scheduled to appear at the venue 20, past, present, and/or future events near the venue 20 (e.g., nearby concerts, sporting events, shows, conventions, or the like), information related to the surrounding market of the venue 20 (e.g., local sports teams, history, industry, organizations, or the like), combinations thereof, and the like. The COD 30 may collect the venue data from the jukebox 70, display devices 40, and/or other peripheral sources (e.g., cable/satellite television boxes), from external sources via the network 50 (e.g., websites or feeds including relevant information, statistics, or the like), or from venue staff (e.g., via a mobile device app, such as Co-Pilot available from AMI ENTERTAINMENT NETWORK, or the like), or the like. In some embodiments, at least some of the venue data may be provided directly to the server 60, such as from venue staff, external sources 50, the jukebox 70, the display devices 40 or the like.

Patron data may include, but is not limited to, for example, age, education, interests, favorites (e.g., favorite sports teams, foods, movies, TV shows, music, and the like), occupation, history (e.g., events previously attended, previous food/drink orders, games previously played, music previously selected, and the like), combinations thereof, and the like. In some embodiments, the patron data may be a combination of information related specifically to the trivia game, such as a combination of patron preferences (e.g., one or more specifically selected categories, questions, or the like), patron history (e.g., questions answered, categories or games in which the patron participated, or the like), and location data (e.g., which venues in which the patron played trivia or the like).

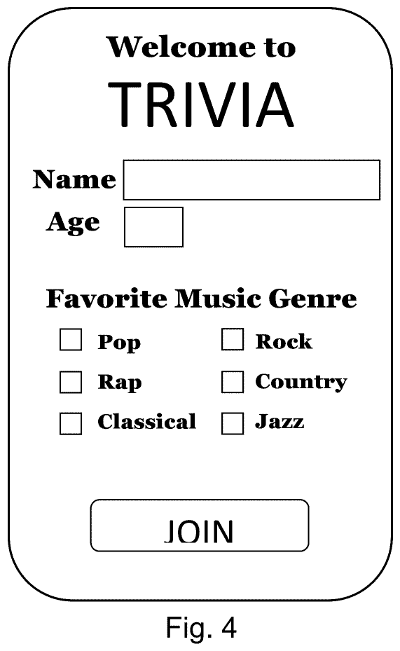

In some embodiments, some of the patron data may be requested via the user devices upon patrons requesting to join the game, checking into the venue 20, or at other times while patrons are present at the venue 20. For example, when requesting to join the game, the patron may be directed to a log-in screen where basic information may be requested and sent from the user device 10 to the server 60 (directly or via the COD 30). For example, the log-in screen may appear as shown in FIG. 4 and ask for a user name, age, and a favorite music genre. In another example, patrons may be polled about potential topics for a trivia game to gauge interest, such as favorite school subjects, sports teams, foods, movies, TV shows, and the like. In some embodiments, patrons may have pre-established online accounts with the venue 20, game provider, or other related entity from which patron data may be extracted. For example, upon identifying a patron's account based on the user device 10 (e.g., by signing in or having the user device 10 registered with the account), the server 60 may pull the patron data from the account. Account information may be stored in the server 60 or elsewhere and be retrievable over the Internet or other network to which the server 60 is connected. While patron data may be provided by the user devices 10, the COD(s) 30 at the venue 20 may receive account log-ins or check-ins or other responses to information requests and store the information for sending to the server 60. In still further embodiments, venue staff may be able to provide patron data to the COD(s) 30 and/or the server 60 as well, such as via a mobile device app or the like.

Although venue and patron data are described above as being sent by the COD(s) 30 and/or user devices 10 at the time of or after initiation of the trivia game, it is also contemplated that such information may be sent prior to initiation. For example, the server 60 may periodically poll the COD 30 for updates on venue data rather than waiting for initiation of a trivia game. In another example, the COD 30 and/or server may periodically poll user devices 10 to obtain patron counts and/or identify patrons that are present in the venue 20 prior to game initiation.

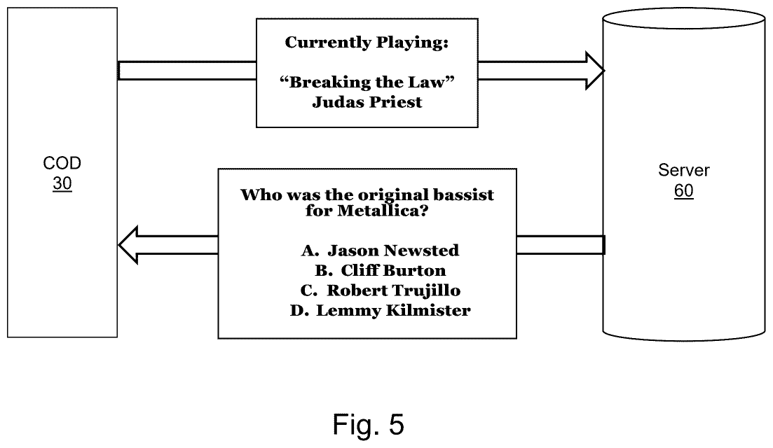

When the server 60 has received sufficient venue and/or patron data, the server 60 may generate or compile a list of questions for use in the trivia game, based at least on the venue and/or patron data. Using the venue and/or patron data, the server 60 may provide the COD 30 with questions for the trivia game that the patrons are likely to have an interest in and may be more likely to answer correctly. For example, FIG. 5 shows a COD 30 providing information to the server 60 related to a song currently playing on a jukebox 70 at the venue 20. Based on the song's genre or other artists affiliated with the artist or song, the server 60 returns a question to the COD 30 that may be provided for use in the trivia game. If the current song playing at the venue 20 were a pop song instead of metal, it would be deduced that the patrons may be pop music fans and thus, trivia questions for the game should skew more toward pop music trivia than metal, for example.

The server 60 may have a pre-established database of possible questions stored locally or elsewhere for access that the server 60 may query based on the received venue and/or patron data. Questions may be organized by topics, difficulty levels, geographical relevance, combinations thereof, or the like. In such embodiments, the server 60 may compile a list of questions from the candidates in the database most responsive to the query and send one or more of the questions back to the COD 30. The server 60 may take certain additional information into account prior to sending the question(s), such as whether the question has been used recently in a game at the venue 20. In some other embodiments, the server 60 may access the Internet and/or other sources for potential questions based on the venue and/or patron data received. For example, the server 60 may formulate a query for questions relating to various topics and difficulty levels, run the query through a search engine, and compile questions from the search results. In still other embodiments, the server 60 may implement or access a large language model (LLM) or other artificial intelligence (AI) programming trained to write or generate questions in response to the venue and/or patron data received to ensure question relevance and interest.

Once the questions are selected/generated by the server 60 and received at the COD 30, the COD 30 may parse and display the questions as appropriate. For example, the COD 30 may provide the question on one or more of the display devices 40, along with multiple choice answers and designations (e.g., A, B, C, or D). The COD 30 may further present the selectable answers (as well as the question, if desired) to the user devices 10. In some embodiments, the display device(s) 40 may only provide the question and the answer choices may be provided solely on the user devices 10. While multiple choice options are preferred, other types of questions requiring, e.g., numerical responses, written responses, combinations thereof, or the like, may be used as well. Patrons may transmit their responses to the COD 30 using their respective user devices 10. When a time period for answering expires or when all participants have transmitted their responses, the COD 30 may display the correct answer on the display device(s) 40 and/or the user devices 10. The COD 30 may also calculate scores for participants based on the received responses. The process of the COD 30 presenting questions and receiving responses relating to the trivia game may repeat until the game is completed. While FIG. 2 shows the server 60 sending multiple questions to the COD 30 in advance of starting game play, questions may be provided serially, including during game play.

As shown in FIG. 2, the COD 30 and the server 60 may optionally exchange intermittent data during game play. For example, the COD 30 may report data related to the game, such as the rate at which patrons are answering questions correctly or incorrectly, time spent per question, information about patrons entering or exiting the game, changes to music being played on the jukebox 70, changes to entertainment content being displayed at the venue 20, combinations thereof, or the like. The server 60 may use this data to make real-time dynamic in-game adjustments. For example, the server 60 may adjust the difficulty level of questions being presented by the COD 30 (e.g., by sending easier/harder questions or directing the COD 30 to easier/harder questions previously received) as a result of too many patrons or too few answering correctly or based on information from new players entering the game. As another example, as music on the jukebox changes (e.g., genre, artist, or the like), the server 60 may adjust the questions to adapt to better suit the perceived audience at the venue 20. It may also be possible in other embodiments for the COD 30 itself to adjust game play in real-time based on received data rather than receiving instructions to do so from the server 60.

Upon completion of the game, the COD 30 may calculate the final scores and/or determine a winner of the game. The COD 30 may output the scores and/or winner information to the participating user devices 10, where the information is displayed for the participating patrons. The scores and/or winner information may also be transmitted to the display device(s) 40 so that other patrons of the venue who were not participating in the game can view the results. In some embodiments, the COD 30 may also report the scores and/or winner information to the server 60 or other account managing device for storage in related user accounts.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The terms “program” or “software” are used herein in a generic sense to refer to any type of computer code or set of computer-executable instructions that can be employed to program a computer or other processor to implement various aspects of the concepts discussed above. The computer program need not reside on a single computer or processor, but may be distributed in a modular fashion amongst a number of different computers or processors to implement various aspects.

Computer-executable instructions may be in many forms, such as program modules, executed by one or more computers or other devices. Generally, program modules include routines, programs, objects, components, data structures, and the like, that perform particular tasks or implement particular abstract data types. The functionality of the program modules may be combined or distributed as desired in various embodiments.

Data structures may be stored in non-transitory computer-readable media in any suitable form. For simplicity of illustration, data structures may be shown to have fields that are related through location in the data structure. Such relationships may likewise be achieved by assigning storage for the fields with locations in a non-transitory computer-readable medium that conveys relationship between the fields. However, any suitable mechanism may be used to establish a relationship between information in fields of a data structure, including through the use of pointers, tags or other mechanisms that establish relationship between data elements.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

While specific and distinct embodiments have been shown in the drawings, various individual elements or combinations of elements from the different embodiments may be combined with one another while in keeping with the spirit and scope of the invention. Thus, an individual feature described herein only with respect to one embodiment should not be construed as being incompatible with other embodiments described herein or otherwise encompassed by the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined herein.

We claim:

1. A system for dynamically generating trivia questions for a multiplayer trivia game at a venue, the system comprising:
a server; and
a content output device deployed at the venue and connected by a network to the server, the content output device being communicatively couplable to one or more display devices deployed at the venue and configured for communication with one or more user devices participating in the multiplayer trivia game at the venue,
the server being configured to:
(i) receive venue data from the content output device over the network,
(ii) receive patron data associated with users of the one or more user devices participating in the multiplayer trivia game at the venue,
(iii) generate or compile one or more trivia questions based on at least one of the received venue data or patron data, and
(iv) transmit the one or more trivia questions to the content output device over the network,
the content output device being configured to:
(v) present at least one of the one or more trivia questions on at least one of the one or more display devices or the one or more user devices participating in the multiplayer trivia game, and
(vi) receive, from the one or more user devices participating in the multiplayer trivia game, responses to the at least one of the one or more trivia questions.

2. The system of claim 1, further comprising a jukebox deployed at the venue and communicatively coupled to the content output device.

3. The system of claim 2, wherein the venue data provided by the content output device to the server includes an identification of music at least one of currently playing on or recently played on the jukebox.

4. The system of claim 3, wherein the identification of music includes at least one of music genre, artist name, or lyrics.

5. The system of claim 1, wherein the patron data includes identification of user accounts associated with each of the users of the one or more user devices participating in the multiplayer trivia game at the venue.

6. The system of claim 5, wherein the server is configured to, upon receiving the identification of a particular user account, pull additional patron data for the user associated with the particular user account.

7. The system of claim 1, wherein the venue data provided by the content output device to the server includes an identification of video content at least one of currently displaying on or recently displayed on at least one of the one or more display devices at the venue.

8. The system of claim 1, wherein the patron data includes at least one of age, education, interests, favorites, or occupation of each of the users of the one or more user devices participating in the multiplayer trivia game at the venue.

9. The system of claim 1, wherein the patron data is received by the server from the one or more user devices participating in the multiplayer trivia game at the venue.

10. The system of claim 1, wherein the server includes a database of possible trivia questions, the server being configured to compile the one or more trivia questions from the database based on the at least one of the received venue data or patron data.

11. A method of operating a multiplayer trivia game with dynamically generated trivia questions at a venue, a content output device being deployed at the venue and connected by a network to a server, the content output device being communicatively couplable to one or more display devices deployed at the venue and configured for communication with one or more user devices participating in the multiplayer trivia game at the venue, the method comprising:
sending, by the content output device, venue data over the network to the server;
receiving, by the content output device, one or more trivia questions over the network from the server, the one or more trivia questions being generated or compiled by the server based on at least one of the venue data or patron data associated with users of the one or more user devices participating in the multiplayer trivia game at the venue;
presenting, by the content output device, at least one of the one or more trivia questions on at least one of the one or more display devices or the one or more user devices participating in the multiplayer trivia game; and
receiving, by the content output device, responses to the at least one of the one or more trivia questions from the one or more user devices participating in the multiplayer trivia game.

12. The method of claim 11, wherein the content output device is communicatively coupled to jukebox deployed at the venue, and wherein the venue data sent by the content output device over the network to the server includes an identification of music at least one of currently playing on or recently played on the jukebox.

13. The method of claim 12, wherein the identification of music includes at least one of music genre, artist name, or lyrics.

14. The method of claim 11, further comprising sending, by the content output device, the patron data over the network to the server.

15. The method of claim 14, further comprising receiving, by the content output device, the patron data from the one or more user devices participating in the multiplayer trivia game at the venue.

16. The method of claim 11, further comprising initiating, by the content output device, the multiplayer trivia game.

17. The method of claim 16, wherein the content output device performs the initiating step in response to receiving a request to play from at least one of the one or more user devices.

18. The method of claim 11, wherein the venue data sent by the content output device over the network to the server includes an identification of video content at least one of currently displaying on or recently displayed on at least one of the one or more display devices at the venue.

19. The method of claim 11, wherein the patron data includes at least one of age, education, interests, favorites, or occupation of each of the users of the one or more user devices participating in the multiplayer trivia game at the venue.

20. The method of claim 11, further comprising:
determining, by the content output device based on the responses received to the at least one of the one or more trivia questions from the one or more user devices participating in the multiplayer trivia game, a winner of the multiplayer trivia game; and
identifying the winner on at least one of the one or more display devices at the venue.
